(19) United States
(12) Patent Application Publication
(10) Pub. No.: US 2026/0051282 A1
(43) Pub. Date: Feb. 19, 2026

(54) OPTOELECTRONIC DEVICE

(71) Applicant: Aledia, Echirolles (FR)

(72) Inventors: Jaehoon Lee, Grenoble (FR); Hugues Lebrun, Coublevie (FR)

(73) Assignee: Aledia, Echirolles (FR)

(21) Appl. No.: 19/114,617

(22) PCT Filed: Sep. 28, 2023
(86) PCT No.: PCT/EP2023/076861

§ 371 Date: Mar. 24, 2025

(30) Foreign Application Priority Data
Sep. 29, 2022 (FR) FR2209864

(51) Int. Cl. G09G 3/32

(52) U.S. Cl. CPC G09G 3/32; G09G 2300/0857; G09G 2320/0626; G09G 2320/0693

(57) ABSTRACT

A pixel including: a light emitting element; a memory including at least one non-volatile memory cell; a first switch including a first output terminal coupled to the light emitting element, a second output terminal coupled to the non-volatile memory and an input terminal coupled to a supply node by a transistor; and a control circuit configured to generate a control voltage on a control terminal of the transistor, the control voltage being equal to: a first voltage during a step of resetting at least one cell of the memory; a second voltage during a step of setting at least one cell of the memory; a third voltage during a step of driving the element.

### TECHNICAL FIELD

The present disclosure relates generally to optoelectronic device, more particularly to devices comprising pixels, and their drivers.

### BACKGROUND ART

A pixel of an image corresponds to the unit element of the image displayed by a display screen. For the display of color images, the display screen generally comprises, for the display of each pixel of the image, at least three components, also called display sub-pixels, which each emit a light radiation, called image pixel color component substantially in a single color (for example, red, green, and blue). The superposition of the image pixel color components emitted by the three display sub-pixels provides the observer with the colored sensation corresponding to the pixel of the displayed image. In this case, the assembly formed by the three display sub-pixels used for the display of a pixel of an image is called display pixel of the display screen. Each display sub-pixel may comprise a light source, particularly a light-emitting diode.

The display pixels may be distributed in an array, each display pixel being located at the intersection of a row (also called line) and of a column of the array. Each display pixel for example comprises a light emitting element and associated electronics, for example a driver. Electrodes are provided along the rows and the columns to connect each display pixels to control circuits. Generally, each row of display pixels is successively selected by a signal ROW transmitted along the row electrodes, and the display pixels of the selected row are programmed to display the desired image pixels by signals col transmitted along the column electrodes.

Pixels are generally made to be identical. Therefore, pixels supposed to generate a same brightness are provided with a same control signal. However, the components of a display pixel comprise, by fabrication, variations. The brightness generated by a pixel might not correspond to the wanted brightness.

### SUMMARY OF INVENTION

One embodiment addresses all or some of the drawbacks of known optoelectronic devices.

One embodiment provides a pixel comprising:
a transistor;
a light emitting element;
a memory comprising at least one phase change memory cell;
a first switch comprising a first output terminal coupled to the light emitting element, a second output terminal coupled to the phase change memory and an input terminal coupled to a supply node by the transistor, the first switch being configured to connect the input terminal either to the first output terminal or to the second output terminal; and
a control circuit configured to generate a control voltage on a control terminal of the transistor, the control voltage being equal to:
a first voltage during a step of resetting at least one cell of the memory;
a second voltage during a step of setting at least one cell of the memory;
a third voltage during a step of driving the element. Such an embodiment allows the calibration of each pixel independently.

Such a pixel generates a low static current. Such a pixel permits the storage of data with a lower voltage than previously known circuits, comprising for example volatile memory cells. The pixel does not need an analog circuit dedicated to the generation of the high voltage used to program volatile cells, which allows the decrease of the size of the pixel.

According to an embodiment, the first voltage is higher than the second voltage and the second voltage is higher than the third voltage.

According to an embodiment, the first switch is configured to connect the second output and the input of the first switch during the steps of setting and resetting of the memory cells, and to connect the first output and the input of the first switch during the step of driving the element.

According to an embodiment, during a step of reading at least one memory cell of the memory, the control voltage is equal to the third voltage and the first switch is configured to connect the second output and the input of the first switch.

According to an embodiment, the transistor is coupled to the supply node by a second switch.

According to an embodiment, the second switch is configured to be closed for a first duration during the step of setting, for a second duration during the step of resetting and for a third duration during the step of driving the element.

According to an embodiment, the first duration is longer than the second duration and the second duration is longer than the third duration.

According to an embodiment, the memory comprises between 20 and 50 cells.

According to an embodiment, the memory comprises a third switch comprising an input coupled to the second input terminal and an output coupled to each memory cell.

According to an embodiment, the light emitting element is a light emitting diode.

Another embodiment provides a display screen comprising a plurality of pixels described before.

Another embodiment provides a calibration method of the pixel described previously, comprising:
reading data in the memory;
driving the element according to the data read in the memory;
measuring the brightness of the element;
comparing the brightness to a set value;
if the brightness differs from the set value, modifying the value of said data by steps of setting and resetting.

This calibration method, applied to the pixel, ensure that all the pixel of a display system generate the same brightness regardless of individual variations of manufacture.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 illustrates an example of optoelectronic device;

FIG. 2 illustrates, schematically, an example of a pixel;

FIG. 3 illustrates, in more detail, a part of the pixel of FIG. 2 according to an embodiment;

FIG. 4 illustrates, in more detail, a part of the embodiment of FIG. 3;

FIG. 5 illustrates several operations of the embodiment of FIG. 3;

FIG. 6 illustrates in more details the different operations of the embodiment of FIG. 3;

FIG. 7 illustrates an example of circuit of generation of the voltage VGS;

FIG. 8 illustrates another example of circuit 73 of generation of the voltage VGS; and

FIG. 9 illustrates the method of calibration of the embodiment of FIG. 3.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the Following Disclosure, Unless Indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

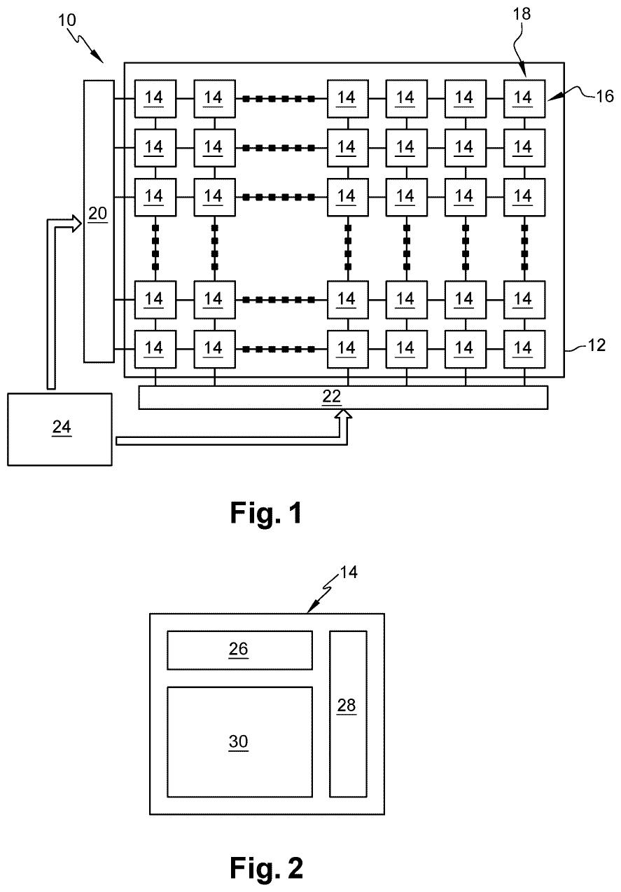

FIG. 1 illustrates an example of optoelectronic device 10.

The device 10 comprises a screen 12. The screen 12 is for example configured to project light, pictures or videos. The screen comprises an array of pixels 14. The screen 12 for example comprises at least one million pixels, for example at least two million pixels, for example at least eight million pixels. The screen comprises rows 16 of pixels 14 and columns 18 of pixels 14.

The device 10 further comprises a row control circuit, or driver, 20 and a column control circuit, or driver, 22. The circuit 20 is configured to provide row voltages ROW, in other words to provide control voltages common to all the pixels of a same row. Similarly, the circuit 22 is configured to provide column voltages COL, in other words to provide control voltages common to all the pixels of a same column. For example, the signal ROW corresponds to the line selection and to the clock signal in illumination mode, for example in pulse width modulation (PWM) mode. For example, the signal COL corresponds to the illumination data, for example video data.

The device 10 for example comprises a controller 24 configured to provide the circuits 20 and 22 the data to generate the voltages ROW and COL. The controller 24 can also provide the clock signal to the circuits 20 and 22, and eventually to the pixels 14. The controller 24 is for example a timing controller.

FIG. 2 illustrates, schematically, an embodiment of a pixel 14. The pixel 14 comprises a first region 26, a second region 28 and a third region 30.

The first region 26 comprises at least one light emitting element. For example, the light emitting element is, in the rest of the description, a light emitting diode, for example an inorganic light emitting diode. However, the light emitting element can be any kind of light emitting component. Preferably, the light emitting element is controlled by the current crossing it. The first region comprises for example three light emitting diodes, a diode configured to provide blue light, a diode configured to provide green light, a diode configured to provide red light.

The second region 28, or non-volatile memory region, comprises at least one non-volatile memory cell. The memory region 28 is configured to store data for the pixel 14, for example calibration data. The size of the memory 28 is dependent on the application. The memory 28 comprises for example between 2 to 2000 memory cells. The pixel 14 can also comprise at least one other memory, for example a volatile memory, for example configured to store illumination data.

The third region 30 is for example the pixel driver. The third region comprises analog and digital circuits. The third region comprises peripheral circuits. The third region 30 comprises for example a power circuit, configured to provide the supply voltages of the pixels. The third region 30 comprises for example control logic. The third region 30 comprises for example a circuit configured to read and/or write in the memory region.

For example, each pixel comprises only four pads, not represented. In other words, each pixel only receives four external voltages: a supply voltage, a reference voltage, for example the ground GND, a signal ROW transmitted along the row electrodes, and a signal COL transmitted along the column electrodes.

According to an embodiment, the memory 28 is coupled to the region 30 by a circuit configured to write in the memory 28 and by another circuit configured to extract data from the memory. The extracted data is provided to the driver in order to generate the voltage during the driving of the pixel. The extracted data is for example used to calibrate the light emitting element.

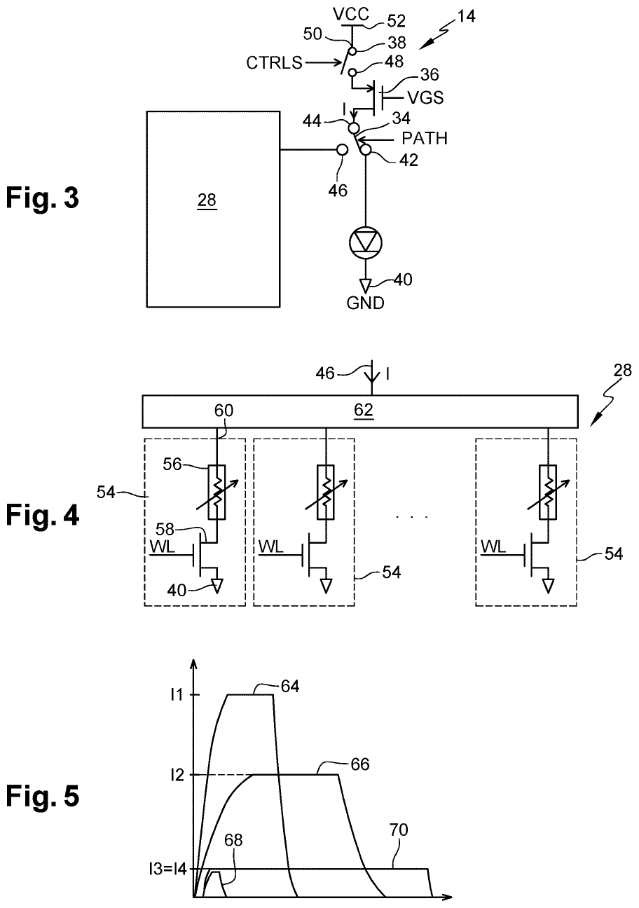

FIG. 3 illustrates, in more detail, a part of the pixel 14 of FIG. 2 according to an embodiment.

The pixel 14 comprises a light emitting diode 32. The diode 32 is for example coupled in series with a switch 34, a transistor 36 and, preferably, a switch 38. The transistor 36 is for example a metal-oxide-semiconductor field-effect transistor (MOSFET), for example a p-channel transistor. The transistor 36 comprises a control terminal, for example a gate, and two conduction terminals, for example a drain and a source. The switch 34 comprises an input terminal 44 and two output terminals 42, 46. The switch 34 is configured to connect the terminal 44 to either the terminal 42 or the terminal 46, depending on a control voltage PATH. The switch 38 comprises two terminals 48 and 50. The switch 38 is configured to connect or not the terminals 48, 50 depending on a control voltage CTRLS.

The diode 32 is coupled between a node 40 of application of a reference voltage, for example the ground GND and the switch 34. In other words, a terminal of the diode 32, for example the cathode, is coupled, preferably connected, to the node 40 and another terminal of the diode, for example the anode, is coupled, preferably connected, to the terminal 42 of the switch 34.

The transistor 36 is coupled between the switch 34 and the switch 38. In other words, the conduction terminal 44 of the transistor 36, for example the drain, is coupled, preferably connected, to the terminal 44 of the switch 34 and the other conduction terminal 48 of the transistor 36, for example the source, is coupled, preferably connected, to the terminal 48 of the switch 38. The control terminal of the transistor 36 is coupled, preferably connected, to a node of application of a control voltage VGS. The terminal 50 of the switch 38 is coupled, preferably connected, to a supply node 52 of application of a supply voltage VCC. Several examples of circuits configured to generate the voltage VGS, at least in some mode of operation, for example the voltage VGS provided while the diode is illuminated.

The terminal 46 of the switch 34 is coupled, preferably connected, to the memory region 28, and more precisely to the memory cells of the memory 28. The memory 28 is preferably a phase change memory. By phase change memory, it is understood a memory comprising at least one phase change memory cell, the phase change memory cell comprising a phase change material whose resistance can alternate between two different values depending on the value of the current crossing the material.

The switch 38 and the transistor 36 are configured to generate a current I and provide the current I to the switch 34.

FIG. 4 illustrates, in more detail, an example of a part of the embodiment of FIG. 3. More precisely, FIG. 4 illustrates, schematically, an example of a memory circuit 28.

The circuit 28 comprises at least one memory cells 54, for example between 2 and 2000 memory cells 54. The memory cells are non-volatile memory cells. The memory cells 54 are resistive memory cells, preferably phase change memory cells.

Each memory cell 54 comprises a memory element 56 and a selection element 58. The selection element is for example a transistor, for example a MOSFET. The elements 56 and 58 are for example coupled in series, for example between an input 60 of the pixel and the node 40 of application of the reference voltage GND. More precisely, a terminal of the element 56 is coupled, preferably connected, to the input 60 and the other terminal of the element 56 is coupled, preferably connected, to a conduction terminal of the element 58. The other conduction terminal of the transistor 58 is coupled, preferably connected, to the node 40. The control terminal, or gate, of the element 58 is coupled, preferably connected, to a node of application of a word line signal WL. The signal WL for example correspond to binary signal. The first value of the signal WL is for example so that the cell 54 receiving it can be read and/or written, and the second value of the signal WL is for example so that the cell 54 receiving it cannot be read and/or written. The signal WL is for example generated by the control logic in the region 30 (FIG. 2).

The resistance of the element 56 can be modified. If a current having a first value go through the element 56, the resistance of the element 56 takes a first value, corresponding to a first binary value. If the current going through the element 56 has a second value, the resistance of the element 56 takes a second value, corresponding to a second binary value. Each element 56 is for example in a phase change material.

The circuit 28 further comprises a switch array 62. The switch array 62 comprises an input coupled, preferably connected, to the terminal 46. The switch array comprises at least as many outputs as there is memory cells 54. Each input 60 of the memory cells 54 is coupled, preferably connected, to an output of the switch array 62. The current I can therefore be dispatched to the memory cell 54 being read or written.

### Alternatively, the Memory Circuit 28 Can Have a different configuration.

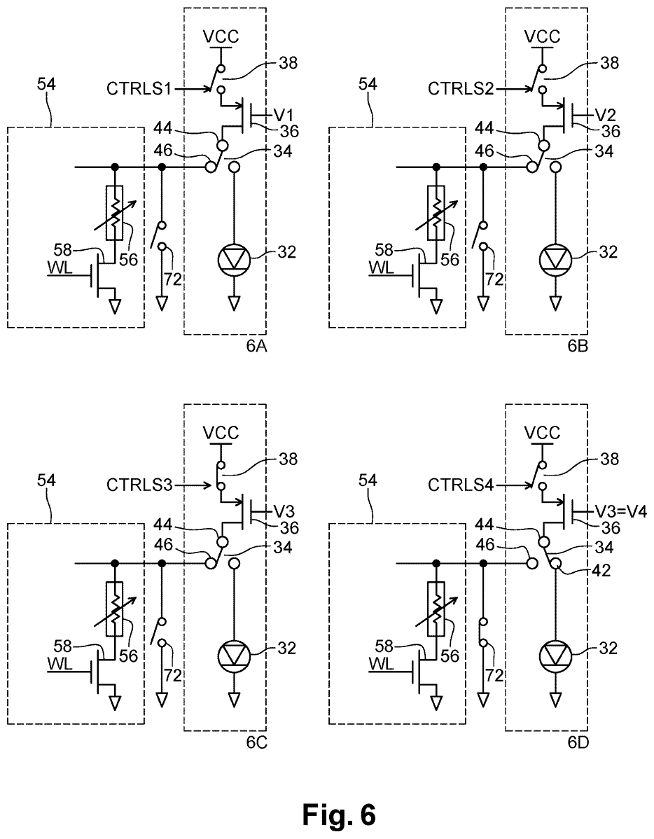

FIG. 5 illustrates several operations of the embodiment of FIG. 3. More precisely, FIG. 5 illustrates the current I during different operations of the embodiment of FIG. 3, as a function of time (t).

A curve 64 represents the current I generated to reset a memory cell 54, in other words to write a first binary value in said memory cell 54. A curve 66 represents the current I generated to set a memory cell 54, in other words to write a second binary value in said memory cell 54. A curve 68 represents the current I generated to read the content of a memory cell 54. A curve 70 represents the current I generated to illuminate the light emitting diode.

Each curve 64, 66, 68, 70 comprises a first period of increase from a low value, for example substantially equal to zero ampere, to a high value, a second period wherein the value of the current I is maintained at the high value I1, I2, I3, a third period of decrease from the high value to the low value and a fourth period wherein the value of the current I is substantially equal to the low value. The second period correspond to a pulse.

The low values of the curves 64, 66, 68, 70 are for example identical. The high value I1 of the curve 64 and the duration of the second period of the curve 64 correspond to the current used to reset the memory cells 54. The high value I2 of the curve 66 and the duration of the second period of the curve 66 correspond to the current used to set the memory cells 54. The high value I3 of the curve 68 and the duration of the second period of the curve 68 correspond to the current used to read the memory cells 54. The high value I4 of the curve 70 and the duration of the second period of the curve 70 correspond to the current used to drive the light emitting diode. In other words, the memory cells are set, reset or read and the light emitting diode are illuminated when the current has the value of the second period of the corresponding curve.

The high value Il of the curve 64 is higher than the high value I2 of the curve 66. The high value I2 of the curve 66 is higher than the high value I3 of the curve 68. The high value I3 of the curve 68 is substantially equal to the high value I4 of the curve 70. Furthermore, the duration of the second period of the curve 64 is smaller than the duration of the second period of the curve 66. While the duration of the second period of the curve 66 is smaller than the duration of the second period of the curve 70 in the example of FIG. 5, the duration of the second period of curve 70 depends on the illumination data, and therefore can have a different duration. The duration of the second period of the curve 68 is smaller than the duration of the second period of the curve 64.

The intensity of the current I during the second period of each curve, corresponding to the high value, is for example determined by the voltage VGS applied on the control terminal of the transistor 36. The duration of the second period is determined by the voltage CTRLS, which control the switch 38. In other words, the voltage VGS is configured to have first V1, second V2 a third V3 value, the first value configured ensure that the current going through the transistor 36 has the intensity I1, the second value configured ensure that the current going through the transistor 36 has the intensity I2, and the third value configured ensure that the current going through the transistor 36 has the intensity I3. The first, second, and third values are distinct. The first value of the voltage VGS is for example higher than the second value of the voltage VGS. The second value of the voltage VGS is for example higher than the third value of the voltage VGS.

FIG. 6 illustrates in more details the different operations of the embodiment of FIG. 3. More precisely, FIG. 6 comprises four views 6A, 6B, 6C and 6D respectively representing the resetting of the memory cells, the setting of the memory cells, the reading of the memory cells and the driving of the light emitting diodes.

In the view 6A, corresponding to the resetting of the memory cells, the voltage VGS, having the first value V1, is applied to the control terminal, for example the gate, of the transistor 36. furthermore, the control terminal of the switch 38 receives a pulse CTRLS1 ensuring that the switch 38 is closed during a duration corresponding to the duration of the second period of the curve 64. The switch 34 is configured to connect the terminals 44 and 46.

The memory 28 receives the current I corresponding to a resetting. The transistor 58 of the cell or cells to reset receives, on its control terminal, a signal WL having a value configured to allow the passage of the current through the element 56 and the transistor 58. The current passing through the element 56 is configured to modify the phase of the element 56. The transistor 58 of the cell or cells not to be reset receives, on its control terminal, a signal WL having a value configured to stop the passage of the current through the element 56 and the transistor 58. The phase of the elements 58 are therefore unchanged.

If the memory 28 comprises the switch array 62, the array is configured to provide the current I to the cells to reset.

In the view 6B, corresponding to the setting of the memory cells, the voltage VGS, having the second value V2, is applied to the control terminal, for example the gate, of the transistor 36. Furthermore, the control terminal of the switch 38 receives a pulse CTRLS2 ensuring that the switch 38 is closed during a duration corresponding to the duration of the second period of the curve 66. The switch 34 is configured to connect the terminals 44 and 46.

The memory 28 receives the current I corresponding to a setting of the memory. The transistor 58 of the cell or cells to set receives, on its control terminal, a signal WL having a value configured to allow the passage of the current through the element 56 and the transistor 58. The current passing through the element 56 is configured to modify the phase of the element 56. The transistor 58 of the cell or cells not to be set receives, on its control terminal, a signal WL having a value configured to stop the passage of the current through the element 56 and the transistor 58. The phase of the elements 56 are therefore unchanged.

If the memory 28 comprises the switch array 62, the array is configured to provide the current I to the cells to set.

In the view 6C, corresponding to the reading of the memory cells, the voltage VGS, having the third value V3, is applied to the control terminal, for example the gate, of the transistor 36. Furthermore, the control terminal of the switch 38 receives a pulse CTRLS3 ensuring that the switch 38 is closed during a duration corresponding to the duration of the second period of the curve 68. The switch 34 is configured to connect the terminals 44 and 46.

The memory 28 receives the current I corresponding to a reading of the memory. The transistor 58 of the cell or cells to be read receives, on its control terminal, a signal WL having a value configured to allow the passage of the current through the element 56 and the transistor 58. The current passing through the element 56 is not enough to modify the phase of the element 56, but allow the reading of the cell. The transistor 58 of the cell or cells not to be read receives, on its control terminal, a signal WL having a value configured to stop the passage of the current through the element 56 and the transistor 58.

If the memory 28 comprises the switch array 62, the array is configured to provide the current I to the cells to read.

In the view 6D, corresponding to the driving of the light emitting diode 32, the voltage VGS, having the fourth value V4 preferably equal to the third value V3, is applied to the control terminal, for example the gate, of the transistor 36. Furthermore, the control terminal of the switch 38 receives a pulse CTRLS4 ensuring that the switch 38 is closed during a duration corresponding to the duration of the second period of the curve 70. The switch 34 is configured to connect the terminals 44 and 42.

Therefore, the memory 28 does not receive the current I. The diode 32 receives the current I and is illuminated.

If the memory 28 comprises the switch array 62, the array is configured to provide the current I to the cells to drive.

The terminal 46 is for example coupled to the node 40 by a switch 72. In other words, a terminal of the switch 72 is coupled, preferably connected, to the node 40 and another terminal is coupled, preferably connected, to the terminal 46. In views 6A, 6B, 6C, the switch 72 is configured to be open. In view 6D, the switch 72 is configured to be closed, which minimize the static current during the illumination period.

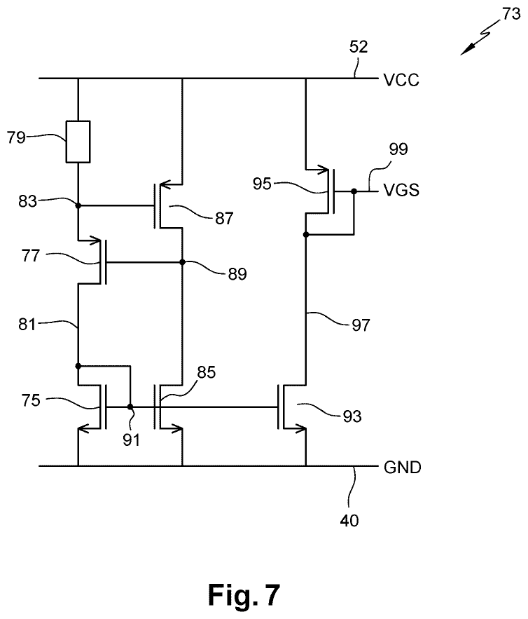

FIG. 7 illustrates an example of circuit 73 of generation of the voltage VGS.

The circuit 73 comprises a transistor 75, a transistor 77 and a resistor 79 coupled in series between the node 40 and the node 52. The transistors 75 and 77 are for example MOSFET. The transistors 75 and 77 are for example respectively a n-channel transistor and a p-channel transistor.

A conductive terminal of the transistor 75, for example the source, is coupled, preferably connected, to the node 40. Another conductive terminal of the transistor 75, for example the drain, is coupled, preferably connected, to a node 81. A conductive terminal of the transistor 77, for example the drain, is coupled, preferably connected, to the node 81. Another conductive terminal of the transistor 77, for example the source, is coupled, preferably connected, to a node 83. A terminal of the resistor 79 is coupled, preferably connected, to the node 83 and another terminal of the resistor 79 is coupled, preferably connected, to the node 52.

The circuit 73 also comprises a transistor 85 and a transistor 87 coupled in series between the node 40 and the node 52. The transistors 85 and 87 are for example MOSFET. The transistors 85 and 87 are for example respectively a n-channel transistor and a p-channel transistor.

A conductive terminal of the transistor 85, for example the source, is coupled, preferably connected, to the node 40. Another conductive terminal of the transistor 85, for example the drain, is coupled, preferably connected, to a node 89. A conductive terminal of the transistor 87, for example the drain, is coupled, preferably connected, to the node 89. Another conductive terminal of the transistor 87, for example the source, is coupled, preferably connected, to the node 52.

The control terminal, or gate, of the transistor 75 is coupled, preferably connected, to a node 91. The control terminal, or gate, of the transistor 85 is coupled, preferably connected, to the node 91, and therefore to the control terminal of the transistor 75. Furthermore, the node 91 is coupled, preferably connected, to the node 81.

The control terminal of the transistor 77 is coupled, preferably connected, to the node 89. The control terminal of the transistor 87 is coupled, preferably connected, to the node 83.

The circuit 73 also comprises a transistor 93 and a transistor 95 coupled in series between the node 40 and the node 52. The transistors 93 and 95 are for example MOSFET. The transistors 93 and 95 are for example respectively a n-channel transistor and a p-channel transistor.

A conductive terminal of the transistor 93, for example the source, is coupled, preferably connected, to the node 40. Another conductive terminal of the transistor 93, for example the drain, is coupled, preferably connected, to a node 97. A conductive terminal of the transistor 95, for example the drain, is coupled, preferably connected, to the node 97. Another conductive terminal of the transistor 95, for example the source, is coupled, preferably connected, to the node 52.

The control terminal of the transistor 93 is coupled, preferably connected, to the node 91. The control terminal of the transistor 95 is coupled, preferably connected, to a node 99. The node 99 is coupled, preferably connected, to the node 97. The node 99 corresponds to the output node of the circuit 73. The voltage VGS is generated on the node 99.

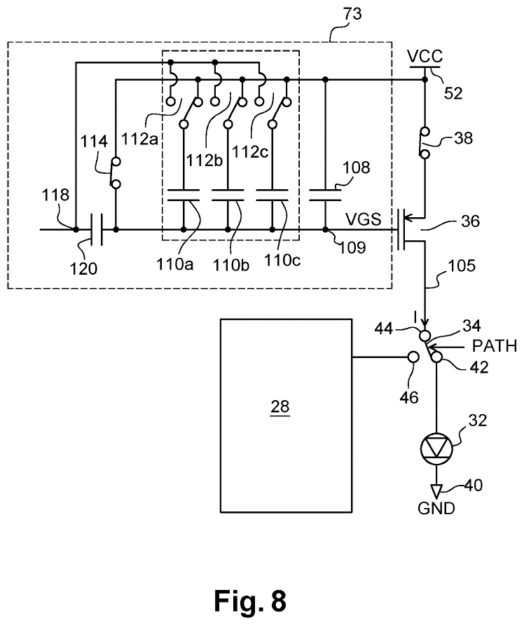

FIG. 8 illustrates the circuit 14 comprising another example of a circuit 73 of generation of the voltage VGS.

The circuit 14 comprises, as the embodiment of FIG. 3, the diode 32, the switch 34, the transistor 36 and the switch 38. The diode 32, the switch 34, the transistor 36 and the switch 38 are coupled in series, between the node 40 and the node 52. The diode 32 is coupled between the node 40 and the switch 34. In other words, the cathode of the diode 32 is coupled, preferably connected, to the node 40 and the anode of the diode 32 is coupled, preferably connected, to the first terminal 42 of the switch 34. the second terminal 44 of the switch 34 is coupled to the node 52 by the transistor 36 and the switch 38. In other words, the second terminal of the switch 34 is coupled, preferably connected, to a node 105, the node 105 being coupled, preferably connected, to a conductive terminal, for example the drain, of the transistor 36 and the other conductive terminal, for example the source, of the transistor 36 is coupled to the node 52 by the switch 38. In other words, the other conductive terminal of the transistor 36 is coupled, preferably connected, to a terminal of the switch 38, the other terminal of the switch 38 being coupled, preferably connected, to the node 52. The switch 34 comprise the other terminal 46, coupled, preferably connected, as in FIG. 3, to the memory 28.

The control terminal of the transistor 36 is coupled, preferably connected, to the circuit 73 configured to generate the voltage VGS.

The circuit 73 comprises a variable voltage divider. In other words, the circuit 73 comprises a voltage divider wherein the proportion between the two capacitive branches is variable.

The voltage divider, and therefore the circuit 73, comprises a capacitor 108. The capacitance of the capacitor 108 is preferably constant. The capacitor 108 is coupled between the control terminal of the transistor 36 and the node 52. A first terminal of the capacitor 108 is coupled, preferably connected, to a node 109, the node 109 being coupled, preferably connected, to the control terminal of the transistor 36. A second terminal of the capacitor 108 is coupled, preferably connected, to the node 52.

The control terminal of the transistor 36 is further coupled to a node 118 of application of a reference voltage. The control terminal of the transistor 36 is coupled to the node 118 by a capacitor 120. The capacitance of the capacitor 120 is preferably constant. More precisely, the control terminal of the transistor 36 is coupled, preferably connected, to a terminal of the capacitor 120. In other words, said terminal of the capacitor 120 is coupled, preferably connected, to the node 109. Another terminal of the capacitor 120 is coupled, preferably connected, to the node 118.

The voltage divider also comprises at least one capacitor 110 coupled in parallel with either the capacitor 108 or the capacitor 120, depending on a control signal. The capacitance of the capacitors 110 are for example constant. The capacitance of the capacitors 110 are for example substantially equal.

In the example of FIG. 8, the divider comprises three capacitors 110, referenced 110a, 110b and 110c. In general, the number of capacitors 110 depend on the application.

Each capacitor 110 is coupled in series with a switch 112. In other words, the capacitor 110a is coupled in series with a switch 112a, the capacitor 110b is coupled in series with a switch 112b, and the capacitor 110c is coupled in series with a switch 112c.

A terminal of each capacitor 110 is coupled, preferably connected, to the node 109. Another terminal of each capacitor 110 is coupled, preferably connected, to an input terminal of the corresponding switch 112. Each switch 112 comprises a first output terminal coupled, preferably connected, to the node 52 and a second output terminal coupled, preferably connected, to the node 118. Each switch 112 is configured to connect the corresponding capacitor 110 to either the node 52 or the node 118 depending on the control voltage. each switch 112 is preferably controlled by its own control voltage, for example independent from the control voltages of the other switches 112.

The value of the voltage VGS is therefore determined by the control voltages of the switches 112, which determines the quotient of the capacitance of the two branches of the voltage divider.

The circuit 106 further comprises a switch 114 coupled between the node 109 and the node 52. The switch 114 comprises a control terminal, for example coupled, preferably connected, to a node of application of a reset voltage.

The memory 28 may comprises several configurations for the voltage divider, in other words several of the control voltages of the switches 112, for example a value corresponding to the voltage V1, a value corresponding to the voltage V2, and a value corresponding to the voltage V3.

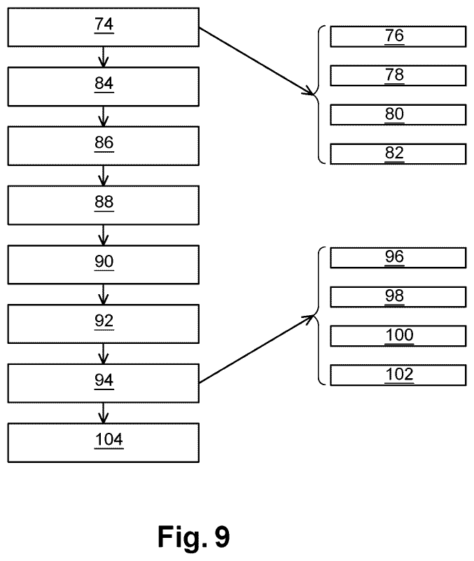

FIG. 9 illustrates steps, preferably successive steps, of a method of calibration of the embodiment of FIG. 3, more precisely the calibration of a pixel.

The method comprises a first illumination of the light emitting diode (block 74). The illumination of the diode comprises the configuration of the circuit to enter the read mode (block 76). For example, entering a reading mode comprises the application of the voltage V3 to the transistor 36, the application of the signal WL to the transistors 58 and the connection of the terminals 44 and 46. The illumination of the diode further comprises the reading of the data in the memory cells (block 78). This corresponds to the view 6C of FIG. 6. This step for example comprises the application of the pulse CTRLS3 to the switch 38. The method comprises a step of writing the video data (block 80) and driving the light emitting mode (block 82), in other words illuminating the diode, for example by a pulse width modulation (PWM) mode. The illumination of the diode corresponds to the view 6D of FIG. 6. The diode is therefore illuminated.

The step of illumination is followed by a step of measuring the brightness and the wavelength generated by the diode (block 84). The measured brightness is then compared with the brightness wanted, for example by a device or circuit external to the pixel. Said device or circuit determines the modification to be made, for example in the value of the voltage VGS and in the duration of the second period of the illumination to obtain the wanted brightness.

For example, the method comprises next a step of reinitialization of the pixel (block 86).

The pixel next enters a programming mode (block 88). The entry in programming mode for example comprises the connection of the terminals 44 and 46 of the switch 34. The method then comprises the programming of the memory (block 90). The data obtained by comparing the obtained brightness and the wanted brightness is programmed in the memory. For example, said data corresponds to a value representing the voltage VGS and the duration of the second period. The programming comprises for example one or more steps of setting, corresponding to view 6B of FIG. 6, and resetting, corresponding to view 6A of FIG. 6.

For example, the method comprises next a step of reinitialization of the pixel (block 92).

The method comprises a second illumination of the light emitting diode (block 94). The illumination of the diode comprises, as in the first illumination, the configuration of the circuit to enter the read mode (block 96). For example, entering a reading mode comprises the application of the voltage V3 to the transistor 36, the application of the signal WL to the transistors 58 and the connection of the terminals 44 and 46. The illumination of the diode further comprises the reading of the data in the memory cells (block 98). This corresponds to the view 6C of FIG. 6. This step for example comprises the application of the pulse CTRLS3 to the switch 38. The method comprises a step of writing the data (block 100) and driving the light emitting mode (block 102), in other words illuminating the diode, for example by a pulse width modulation (PWM) mode. The illumination of the diode corresponds to the view 6D of FIG. 6. The diode is therefore illuminated.

The step of second illumination is followed by another step of measuring the brightness generated by the diode (block 104). The measured brightness is then compared with the brightness wanted, for example by a device or circuit external to the pixel. If the brightness is at the wanted level, the calibration is finished. If the brightness is not at the wanted level, said device or circuit determines the modification to be made, for example in the value of the voltage VGS and in the duration of the second period of the illumination to obtain the wanted brightness. The method continues with the steps of the block 88.

An advantage of the embodiments is that the use of a phase change memory permits the storage of data with a lower voltage than previously known circuits, comprising for example volatile memory cells. The pixel does not need an analog circuit dedicated to the generation of the high voltage used to program volatile cells, which allows the decrease of the size of the pixel.

Another advantage of the embodiments is that each pixel generates zero static current during the pixel operation, therefore decreasing the power consumption of the display system.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A pixel comprising:
a transistor
a light emitting element;
a memory comprising at least one non-volatile memory cell;
a first switch comprising a first output terminal coupled to the light emitting element, a second output terminal coupled to the non-volatile memory and an input terminal coupled to a supply node by the transistor, the first switch being configured to connect the input terminal either to the first output terminal or to the second output terminal; and
a control circuit configured to generate a control voltage on a control terminal of the transistor, the control voltage being equal to:
a first voltage during a step of resetting at least one cell of the memory;
a second voltage during a step of setting at least one cell of the memory;
a third voltage during a step of driving the element.

2. Pixel according to claim 1, wherein the first voltage is higher than the second voltage and the second voltage is higher than the third voltage.

3. Pixel according to claim 1, wherein the first switch is configured to connect the second output and the input of the first switch during the steps of setting and resetting of the memory cells, and to connect the first output and the input of the first switch during the step of driving the element.

4. Pixel according to claim 1, wherein, during a step of reading at least one memory cell of the memory, the control voltage is equal to the third voltage and the first switch is configured to connect the second output and the input of the first switch.

5. Pixel according to claim 1, wherein the transistor is coupled to the supply node by a second switch.

6. Pixel according to claim 5, wherein the second switch is configured to be closed for a first duration during the step of setting, for a second duration during the step of resetting and a third duration during the step of driving the element.

7. Pixel according to claim 6, wherein the first duration is longer than the second duration and the second duration is longer than the third duration.

8. Pixel according to claim 1, wherein the memory comprises between 20 and 50 cells.

9. Pixel according to claim 1, wherein the memory comprises a third switch comprising an input coupled to the second input terminal and an output coupled to each memory cell.

10. Pixel according to claim 1, wherein the light emitting element is a light emitting diode.

11. A display screen comprising a plurality of pixels according to claim 1.

12. A calibration method of the pixel according to claim 1, comprising:
reading data in the memory;
driving the element according to the data read in the memory;
measuring the brightness of the element;
comparing the brightness to a set value;
if the brightness differs from the set value, modifying the value of said data by steps of setting and resetting.

13. Pixel according to claim 1, wherein the at least one non-volatile memory cell is a phase change memory cell.
